(19) United States
(12) Patent Application Publication
(10) Pub. No.: US 2023/0303004 A1
(43) Pub. Date: Sep. 28, 2023

(54) HAT MOUNT

(71) Applicants: David Avery, Fort Worth, TX (US); Loretta Padilla, Fort Worth, TX (US)

(72) Inventors: David Avery, Fort Worth, TX (US); Loretta Padilla, Fort Worth, TX (US)

(21) Appl. No.: 17/705,381

(22) Filed: Mar. 27, 2022

(51) Int. Cl. B60R 7/10

(52) U.S. Cl. CPC B60R 7/10

(57) ABSTRACT

A hat mount configured to attached to a dashboard withing an interior compartment of a vehicle is presented. The hat mount includes a first surface configured for support of a hat. The hat mount having a planar second surface. The second surface is configured for engagement with a dashboard. The second surface includes a silicone material configured to resist and/or prevent sliding of the hat mount relative to the dashboard. The second surface is configured to withstand high temperatures to resist and/or prevent melting of the second surface during hot weather and ruining the dashboard. The second surface avoids the need to use damaging adhesives or glue.

### FIELD OF THE INVENTION

This invention relates to hat mounts. More particularly, it relates to a hat mount for car interiors.

### BACKGROUND

A dashboard (also called dash, instrument panel (IP), or fascia) is a control panel set within the central console of a vehicle. Usually located directly ahead of the driver, it displays instrumentation and controls for the vehicle's operation. The top of the dashboard is flat and smooth in texture.

Originally, the word dashboard applied to a barrier of wood or leather fixed at the front of a horse-drawn carriage or sleigh to protect the driver from mud or other debris “dashed up” (thrown up) by the horses' hooves. The first known use of the term (hyphenated as dash-board, and applied to sleighs) dates from 1847. Commonly these boards did not perform any additional function other than providing a convenient handhold for ascending into the driver's seat, or a small clip with which to secure the reins when not in use.

When the first “horseless carriages” were constructed in the late 19th century, with engines mounted beneath the driver such as the Daimler Stahlradwagen, the simple dashboard was retained to protect occupants from debris thrown up by the cars' front wheels. However, as car design evolved to position the motor in front of the driver, the dashboard became a panel that protected vehicle occupants from the heat and oil of the engine. With gradually increasing mechanical complexity, this panel formed a convenient location for the placement of gauges and minor controls, and from this evolved the modern instrument panel, although retaining its archaic common name.

Where the dashboard originally included an array of simple controls (e.g., the steering wheel) and instrumentation to show speed, fuel level and oil pressure, the modern dashboard may accommodate a broad array of gauges, and controls as well as information, climate control and entertainment systems.

Contemporary dashboards may include the speedometer, tachometer, odometer, engine coolant temperature gauge, and fuel gauge, turn indicators, gearshift position indicator, seat belt warning light, parking-brake warning light, and engine-malfunction lights. Other features may include a gauge for alternator voltage, indicators for low fuel, low oil pressure, low tire pressure and faults in the airbag (SRS) systems, glove compartment, ashtray and a cigarette lighter or power outlet—as well as heating and ventilation systems, lighting controls, safety systems, entertainment equipment and information systems, e.g., navigation systems.

Due to the flat, smooth top of a dashboard it is unsafe to place any object, specifically a hat on top of the dashboard while a vehicle is in motion. Flying objects from dashboards in moving vehicles cause many accidents a year and are unsafe for objects to rest on the dashboard.

Accordingly, and in light of the foregoing, it would be desirable to have an apparatus which is placed on top of a dashboard in a fixed manner allowing hats to rest on and be secured. The device would keep hats or other objects secured with this apparatus from flying around when a vehicle is in motion.

### BRIEF DESCRIPTION OF THE DRAWINGS

These and other features, aspects, and advantages of the present disclosure will become better understood with regard to the following description, appended claims, and accompanying drawings where:

FIG. 1 is a perspective top view of a hat mount according to an embodiment of this disclosure;

FIG. 2 is a perspective bottom view of a hat mount according to an embodiment of this disclosure;

FIG. 3 is a cross section along the lines II in FIG. 1 of a hat mount according to an embodiment of this disclosure; and,

FIG. 4 is a perspective view of a hat mount in use according to an embodiment of this disclosure.

### DESCRIPTIVE KEY

10 hat mount
12 first surface
14 second surface
16 weight
50 vehicle
51 dashboard
55 interior compartment
H hat

### DETAILED DESCRIPTION

The following disclosure is provided to describe various embodiments of a hat mount 10. The hat mount 10 is configured to secure any sized hat H in place on a dashboard 51 of an interior compartment 55 of a vehicle 50. In a preferred embodiment, the hat mount 10 is manufactured out of solid silicone. In other embodiments, the hat mount 10 includes a silicone base. The hat mount 10 is envisioned to be securely placed on the dashboard 51 without damaging the vehicle 50. Although the exemplary embodiment illustrates and describes the hat mount 10 to be used on a dashboard 51 of a vehicle 50 such as a car or truck, it is appreciated that the hat mount 10 can be used on any surface within the vehicle 50, or indeed within a vehicle 50 other than a car or truck, such as a speedboat or aircraft.

Skilled artisans will appreciate additional embodiments and uses of the present invention that extend beyond the examples of this disclosure. Terms included by any claim that may be presented in any yet-to-be-filed non-provisional patent application are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one (1) of A, B, and C” should be read to permit any of A, B, or C singularly or in combination with the remaining elements. Additionally, such groups may include multiple instances of one (1) or more element in that group, which may be included with other elements of the group. All numbers, measurements, and values are given as approximations unless expressly stated otherwise.

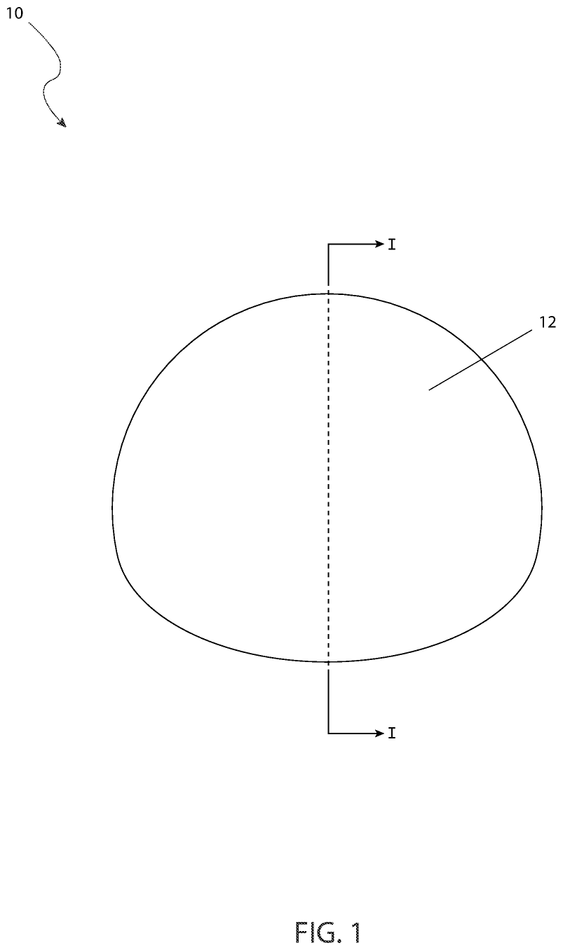

Various aspects of the present disclosure will now be described in detail, without limitation. Skilled readers should not view the inclusion of any alternative labels as limiting in any way. Referring now to FIGS. 1-5, an illustrative hat mount 10 will now be discussed in more detail.

FIG. 1 shows a perspective view of a hat mount 10 configured to attached to a dashboard 52 within an interior compartment 55 of a vehicle 50. The hat mount 10 includes a first surface 12 configured for support of a hat H. In some embodiments, the hat mount 10 includes a half spherical shape. In some embodiments, the hat mount 10 may include various shapes, for example, oval, oblong, triangular, square, polygonal, irregular, uniform, non-uniform, variable, and/or tapered. The hat mount 10 can be made of various materials, for example, metal, plastic, wood or polystyrene. The hat mount 20 can be provided in various colors or patterns.

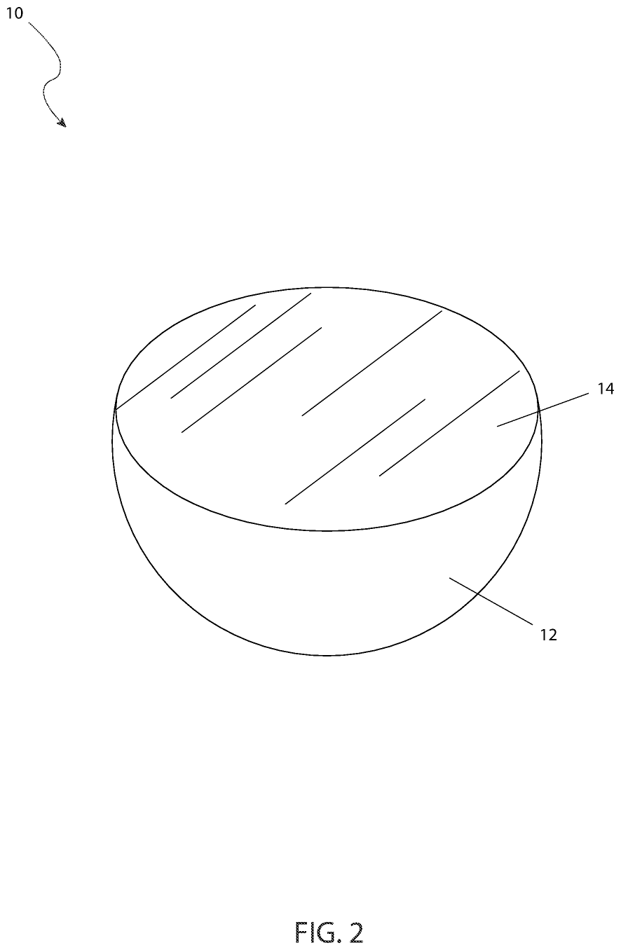

FIG. 2 shows a hat mount 10 having a planar second surface 14. The second surface 14 is configured for engagement with a dashboard 51. The second surface 14 includes a silicone material configured to resist and/or prevent sliding of the hat mount 10 relative to the dashboard 51. The second surface 14 is configured to withstand high temperatures to resist and/or prevent melting of the second surface 14 during hot weather and ruining the dashboard 51. The second surface 14 avoids the need to use damaging adhesives or glue.

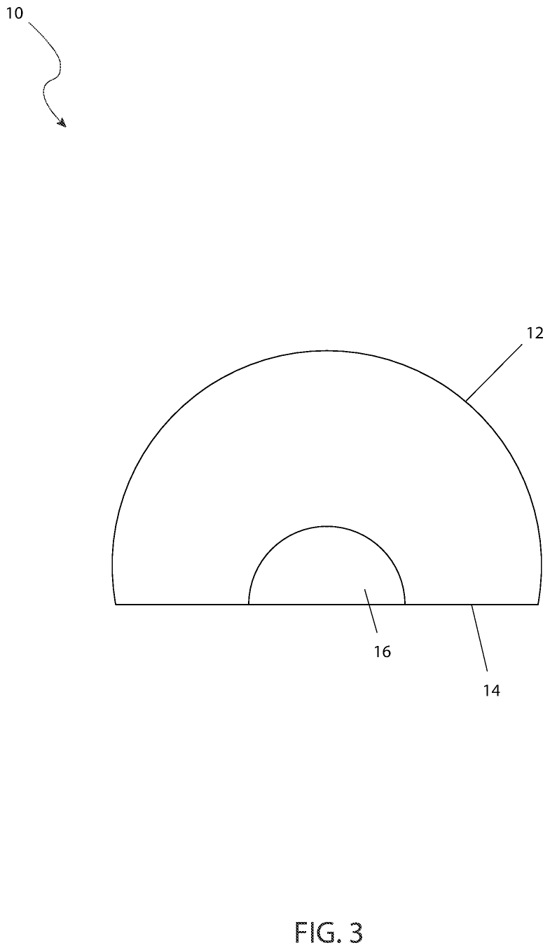

FIG. 3 shows a cross section of a hat mount 10. The hat mount 10 includes a weight 16 configured to hold the hat mount 10 on the dashboard 51. In some embodiments, the weight 16 is centrally disposed to provide for a uniform and even distribution over all or a portion of the second surface 14 to securely retain the hat mount 10 on the dashboard 51. The hat mount 10 is configured to be slim and non-evasive when not in use. In some embodiments, the hat mount 10 appears to blend into the dashboard 51. In other embodiments, the weight 16 may not be present if deemed unnecessary for production purposes or end-use desirability.

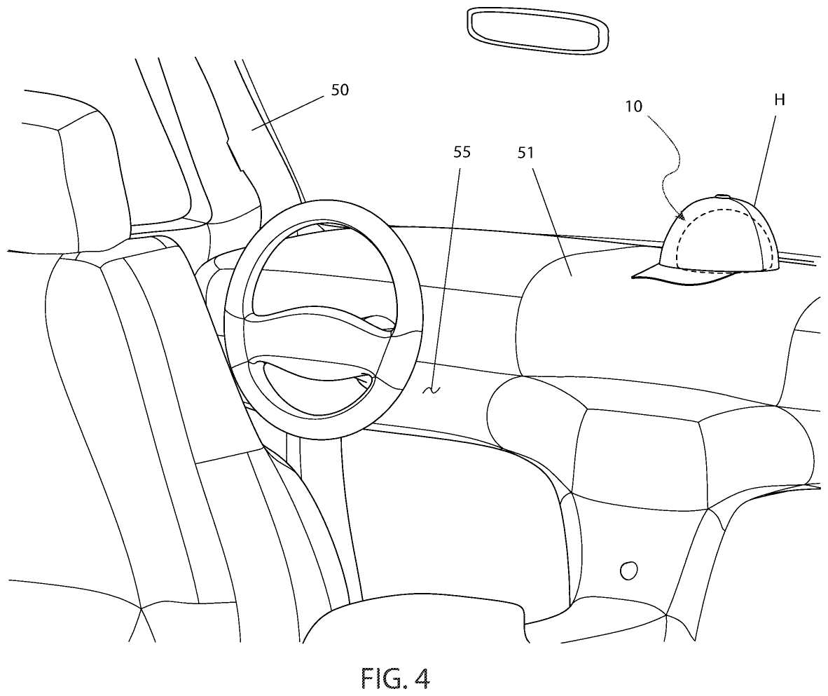

In operation, as shown in FIG. 4, the hat mount 10 is positioned on the dashboard 51. When the user enters the interior compartment 55 of the vehicle 50, a hat H can be placed onto the hat mount 10. The hat mount 10 holds the hat H while the vehicle 10 is in operation. The hat H will not slide across dashboard 51 when turning or fall into the interior compartment 55 of the vehicle 50 during rapid deceleration or re-acceleration or due to uneven terrain the vehicle 50 is travelling on. When the hat mount 10 is placed in another type of vehicle 10, the hat mount 10 can hold the hat H from falling during waking waters, turbulent skies

While various aspects of the present invention have been described in the above disclosure, the description of this disclosure is intended to illustrate and not limit the scope of the invention. Skilled artisans will appreciate additional aspects of the invention, which may be realized in alternative embodiments, after having the benefit of the above disclosure. Other aspects, advantages, embodiments, and modifications are within the scope of the claims.

1. A hat mount for use in a vehicle by attaching the hat mount to a dashboard of the vehicle, the hat mount consisting of:
a first surface, the configured for support of a hat; and
a coupling agent, the coupling agent being for coupling a bottom of the first surface to the dashboard.

2. The hat mount according to claim 1, wherein the coupling agent is a silicone base.

3. The hat mount according to claim 1, wherein the hat mount having a half spherical shape

4. The hat mount according to claim 1, wherein the hat mount having an oval shape. triangular, square, polygonal, irregular, uniform, non-uniform, variable, and/or tapered

5. (canceled)

6. (canceled)

7. The hat mount according to claim 1, wherein the hat mount having an uniform shape.

8. The hat mount according to claim 1, wherein hat mount further comprising a second surface.

9. The hat mount according to claim 8, wherein the second surface having a silicon material for adhering to the dashboard.

10. The hat mount according to claim 8, wherein the hat mount further comprising a weight.

11. The hat mount according to claim 10, wherein the weight has a uniform and even distribution over all of the second surface.

12. The hat mount according to claim 10, wherein the weight is removable.
